(19) United States
(12) Patent Application Publication
(10) Pub. No.: US 2014/0226440 A1
(43) Pub. Date: Aug. 14, 2014

(54) DEPLOYMENT OF SEABED DEVICE

(71) Applicant: Harry George Dennis Gosling, Alveston (GB)

(72) Inventor: Harry George Dennis Gosling, Alveston (GB)

(73) Assignee: GO SCIENCE LIMITED, Bristol (GB)

(21) Appl. No.: 14/345,725

(22) PCT Filed: Sep. 11, 2012
(86) PCT No.: PCT/GB2012/052232

§ 371 Date: Mar. 19, 2014

(30) Foreign Application Priority Data
Sep. 21, 2011 (GB) 1116285.6

(51) Int. Cl. G01V 1/38; B63G 8/08; B63G 8/00

(52) U.S. Cl. CPC G01V 1/38; B63G 8/001; B63G 8/08; B63G 2008/002
USPC 367/16; 114/312; 114/337

(57) ABSTRACT

A method of deploying a device to the seabed with a submersible vehicle, the vehicle having a hull which defines a hull axis and appears substantially annular when viewed along the hull axis. The hull has an interior defining a duct which is open at both ends. The device is mounted to the hull on one or more struts so that it is positioned in line with the duct or at least partially within the duct. The device is transported to the seabed mounted to the hull on the strut(s), water flowing through the duct as it does so. The device is then deployed on the seabed after it has been transported to the seabed by the vehicle.

### FIELD OF THE INVENTION

The present invention relates to a method of deploying a seabed device such as a seismic sensor, and a submersible vehicle/device assembly. It should be noted that the term “seabed” is used herein as a generic term not limited to the bed of a sea, but including the bed of any large body of water such as a sea, lake or river.

### BACKGROUND OF THE INVENTION

A method of deploying seismic sensor nodes is described in WO2006/106085. The nodes are dropped from a support vessel and the trajectory of the nodes is controlled by autonomous guiding equipment. The trajectory of each node can be controlled by movable rudders or by displacing a battery inside the structure of the node. A problem with this arrangement is that the nodes can only be deployed to a point directly below the support vessel, or close by.

Another method of deploying a seismic sensor node is described in WO 02/37140. The node has propulsion fins which transform to coupling and orientation units on the seabed where the fins dig into the sea floor to enhance coupling. A problem with this arrangement is that the node must have a recording housing, power unit, propulsion control unit and buoyancy control unit. These add weight, cost and complexity to the node.

A further method of deploying seismic sensor nodes is described in US 2006/0159524. In one embodiment a carrier containing a plurality of nodes is attached to a remotely operated vehicle (ROV). The ROV transports the nodes to the seabed where they are removed from the carrier and placed on the seabed. A problem with this method is that a complex carrier and deployment mechanism is required. In another embodiment, an ROV adjacent the seabed engages a deployment line extending from the vessel. The deployment line is used to guide nodes attached thereto down to the ROV for “on-time” delivery and placement on the seabed. A problem with this arrangement is that the nodes can only be deployed to a point directly below the support vessel, or close by.

In WO 01/73477, autonomous underwater vehicles (AUVs) deploy and receive seismic sensor nodes to the ocean bottom. Each AUV carries about 10 km of spooled seismic sensor nodes and cable sections on a storage reel. The cable and sensor nodes are paid out from the storage reel and deployed on the ocean bottom. A problem with this method is that a complex storage reel and deployment mechanism is required.

### SUMMARY OF THE INVENTION

A first aspect of the invention provides a method of deploying a device to the seabed, the method comprising providing a submersible vehicle, the vehicle having a hull which defines a hull axis and appears substantially annular when viewed along the hull axis, the hull having an interior defining a duct which is open at both ends; mounting the device to the hull on one or more struts so that it is positioned in line with the duct or at least partially within the duct; transporting the device to the seabed with the device mounted to the hull on the strut(s), water flowing through the duct as it does so; and deploying the device on the seabed after it has been transported to the seabed by the vehicle.

A second aspect of the invention provides a vehicle/device assembly comprising a submersible vehicle with a hull which defines a hull axis and appears substantially annular when viewed along the hull axis, the interior of the hull defining a duct which is open at both ends; and a device which is releasably mounted to the hull of the vehicle on one or more struts and positioned in line with the duct or at least partially within the duct.

The device may be positioned by the struts completely outside the duct (either fore or aft) in line with the duct. However more typically the device is mounted to the hull on the one or more struts so that it is positioned at least partially within the duct, and most preferably entirely within the duct. This makes for a more compact arrangement which makes the vehicle/device assembly more easy to manoeuvre, to stow, and to stack multiple assemblies together.

The device may be deployed by first releasing it from the struts and then allowing it to drop to the seabed under gravity or swim to the seabed under its own motive power.

Alternatively the device may remain mounted to the hull on the strut(s) as it is deployed on the seabed.

The strut(s) may actively deploy the device to the seabed, the (or each) strut moving towards the seabed relative to the hull of the vehicle (for instance by translating or rotating) as it does so. In this case, the vehicle is preferably landed on the seabed before deploying the device with the strut(s). This deployment mode enables the device to be positioned entirely within the duct as it is transported to the seabed.

Optionally the device may be pushed into the seabed. In order to penetrate the seabed, the device preferably comprises a spike, a blade (preferably a serrated blade) or any other part with sharp edges or points suitable for penetrating the seabed. The device may be pushed into the seabed using the momentum of the vehicle and/or using the strut(s) to push the device into the seabed after the vehicle has landed on the seabed.

Preferably the device is transported to the seabed with a nose of the vehicle and a nose of the device pointing down. The vehicle then executes a turn after it reaches the seabed so that the nose of the vehicle and the nose of the device are pointing up. The device is then deployed with the nose of the vehicle and the nose of the device pointing up. Preferably the vehicle comprises a twin thrust vector propulsion system comprising one or more pairs of propulsion devices, each pair comprising a first propulsion device pivotally mounted on a first side of the hull axis, and a second propulsion device pivotally mounted on a second side of the hull axis opposite to the first propulsion device, wherein the device is transported to the seabed with the thrust vectors of the propulsion devices pointing aft in line with the hull axis; wherein the turn is executed by pivoting the propulsion devices so that their thrust vectors point at an acute angle to the hull axis. Preferably the propulsion devices are mounted at least partially within the duct.

The device is typically retrieved from the seabed with the submersible vehicle.

Typically the water flowing through the duct also flows over the device as it is transported to the seabed.

Typically the device creates a hydrodynamic lift force as it is transported to the seabed; and the (or each) strut transmits the hydrodynamic lift force to the vehicle.

Preferably the vehicle is moved away from the device, either after the device has been deployed on the seabed or as the device is deployed on the seabed. The method may further comprise parking the vehicle on the seabed adjacent to the device. Alternatively the vehicle may return to the surface after the device has been deployed, leaving the device on the seabed.

Preferably the (or each) strut is substantially rigid so as to resist compression along its length. This enables the (or each) strut to transmit compressive forces from the device to the hull, either as the device is transported to the seabed or as the device is deployed on the seabed.

Typically the device is released from the (or each) strut, or the (or each) strut is released from the vehicle, after deploying the device and before moving the vehicle away from the device.

The (or each) strut may further comprise a release mechanism for releasing the device from the strut or for releasing the strut from the hull of the vehicle. For instance the (or each) strut may be coupled to the device by a retractable pin, or by a band clamp which can be loosened to release the device.

The device may be releasably mounted to the hull of the vehicle on two or more struts, or by a single strut. Where only a single strut is used, then the strut may have a pair of fingers at its distal end, each finger being mounted to the device.

The device may be any device which must be deployed to the seabed. For instance the device may comprise a sensor for acquiring data such as seismic data, acoustic data, optical data, chemical data, temperature data, pressure data, salinity data, or electromagnetic data. The acquired data may be stored on the sensor, or more preferably the method further comprises transmitting the data to the vehicle via the flexible tether; and storing the data on the vehicle. Alternatively the device may comprise a communication node instead of a sensor.

The device may comprise a seismic sensor with a geophone and/or a hydrophone. Most preferably the seismic sensor comprises three orthogonally oriented geophones, optionally in combination with a hydrophone.

Preferably the device is coupled to the vehicle by a flexible cable as well as by the strut(s). The cable can be used to transmit data from the device to the vehicle (and/or vice versa) and/or the cable can be used to tow the device away from the seabed.

### BRIEF DESCRIPTION OF THE DRAWINGS

Embodiments of the invention will now be described with reference to the accompanying drawings, in which:

FIG. 1 is a perspective view of a seismic sensor node;

FIG. 2 is a rear view of the sensor node;

FIG. 3 is a front view of a vehicle/sensor assembly;

FIG. 4 is a rear view of the vehicle/sensor assembly;

FIG. 5 is a side view of the vehicle/sensor assembly near the seabed;

FIG. 6 is a perspective view of the vehicle/sensor assembly near the seabed;

FIG. 7 is a side view of the vehicle/sensor assembly landed tail down on the seabed;

FIG. 8 is a side view of the vehicle/sensor assembly after the sensor has been embedded and before the struts have been released;

FIG. 9 is a side view of the vehicle/sensor assembly near the seabed, with part of the vehicle shown in section;

FIG. 10 is a side view of the vehicle/sensor assembly after the sensor has been embedded and after the struts have been released;

FIG. 11 is an enlarged side view showing the strut release mechanism;

FIG. 12 is a perspective view showing the vehicle parked next to the sensor;

FIG. 13 is a side view, partly in section, of a vehicle/sensor assembly according to a second embodiment of the invention;

FIG. 14 is a perspective view of the strut and fingers which carry the sensor;

FIG. 15 is a side view of the vehicle/sensor assembly after the sensor has been embedded and before the fingers have been released; and

FIG. 16 shows a method of acquiring seismic data with an array of sensor nodes.

### DETAILED DESCRIPTION OF EMBODIMENT(S)

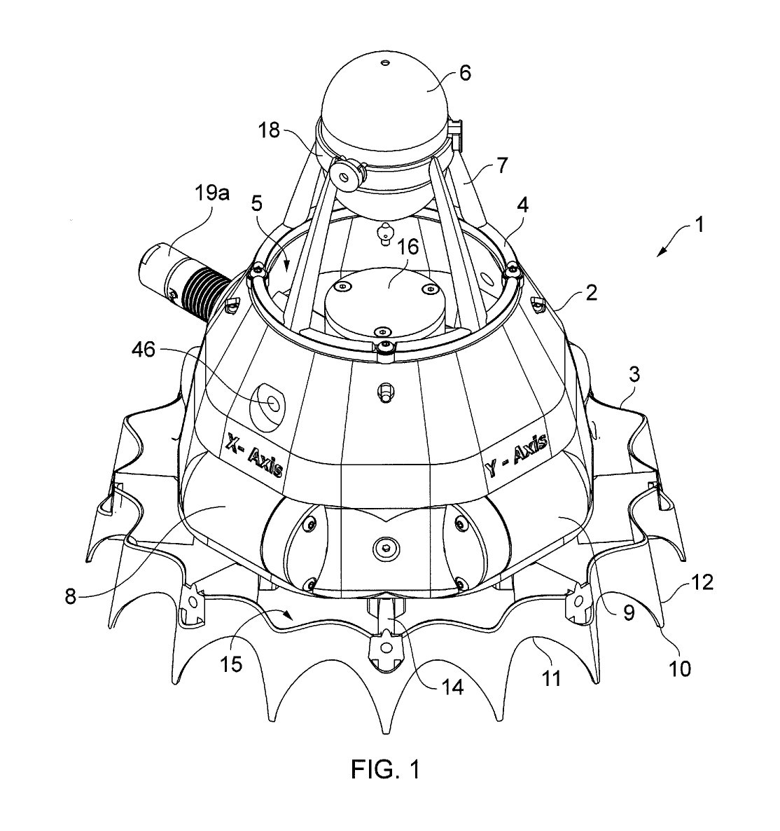

A seismic sensor node 1 shown in FIGS. 1-5 comprises an annular support frame 2 carrying an annular skirt 3 at its lower edge. The support frame 2 and the skirt 3 together define a central annular axis and surround a duct 5 which is open at both its upper and lower ends to permit water to flow through the duct. The duct 5 is flared so that it increases in cross-sectional area as it extends towards the cutting edge of the skirt 3.

The duct 5 has a first (lower) end adjacent to the skirt 3 and a second (upper) end remote from the skirt 3. The cross-sectional area of the first end of the duct 5 (as defined by the skirt 3) is over twice the size of the cross-sectional area of the second end of the duct 5 (as defined by the upper edge 4 of the support frame 2).

A Z-axis geophone sensor 16 is mounted within the duct 5 by four struts 17. An X-axis geophone sensor 8 and a Y-axis geophone sensor 9 are carried by the annular body 2 outside the duct 5. In an alternative embodiment (not shown) the X and Y geophone sensors may be mounted on struts within the duct as well as the Z-axis geophone sensor 16. The struts 17 also carry a pair of accelerometers (not shown) which measure the angle of inclination of the node to the vertical.

The skirt 3 is mounted to the base of the frame 2 by eight struts 14 leaving an open slot 15 between the frame 2 and the skirt 3. The skirt 3 tapers or flares outwardly towards a cutting edge at its lower periphery. The cutting edge appears as a series of inwardly tapering teeth with points 10 when viewed from the side at an angle to the annular axis as shown in FIG. 1. The cutting edge has a curved notch 11 between each adjacent pair of teeth.

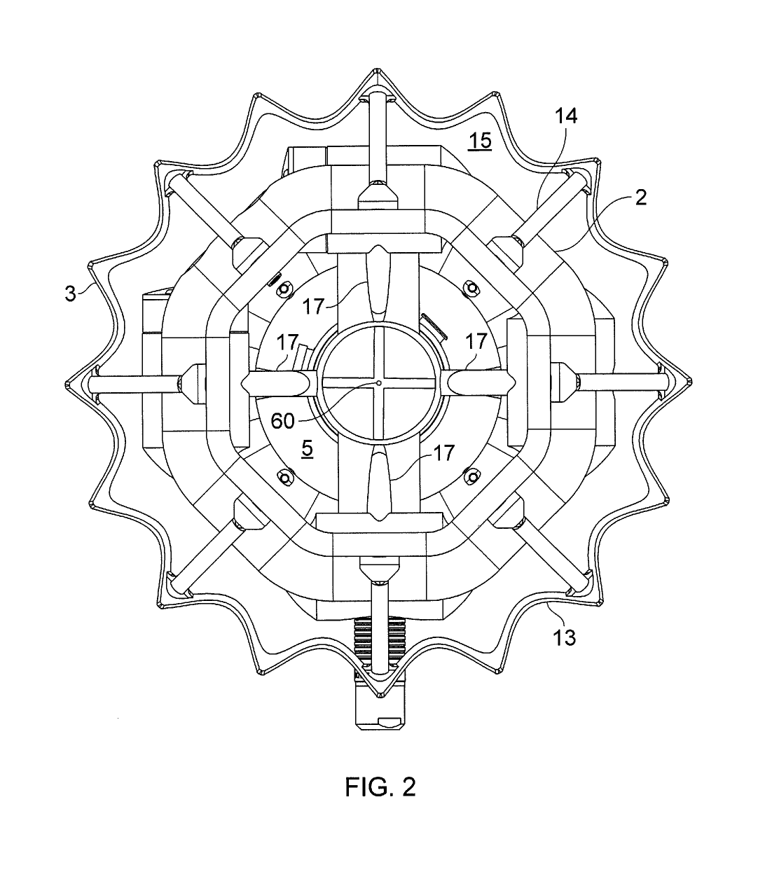

The skirt also has a series of ribs 12 and channels 13 which run towards the cutting edge and terminate at the cutting edge so that the cutting edge has an undulating shape when viewed from below parallel with the annular axis as shown in FIG. 2. Each of the ribs 12 terminates in a respective one of the teeth 10 at its lower edge. Each rib 12 tapers inwardly to a ridge which runs away from the cutting edge, and the channels 13 appear curved when viewed from below as shown in FIG. 2, providing a focusing effect on shear wave seismic energy.

A ring 18 with four struts 7 is mounted to the upper edge of the support frame 2. The ring 18 carries a hydrophone sensor 6.

A spike 60 shown in FIG. 2 extends down from the geophone 16 to a point which lies in the same plane as the points 10 of the teeth. The spike 60 penetrates the seabed along with the skirt 3 and transmits shear waves to the geophone 16. Pressure waves are sensed by the hydrophone 6.

A data port 19a is connected to the geophones 16,8,9 and a data port (not shown) is connected to the hydrophone 6. Cables (not shown) can be connected to the data ports to transmit data to and/or from the sensors.

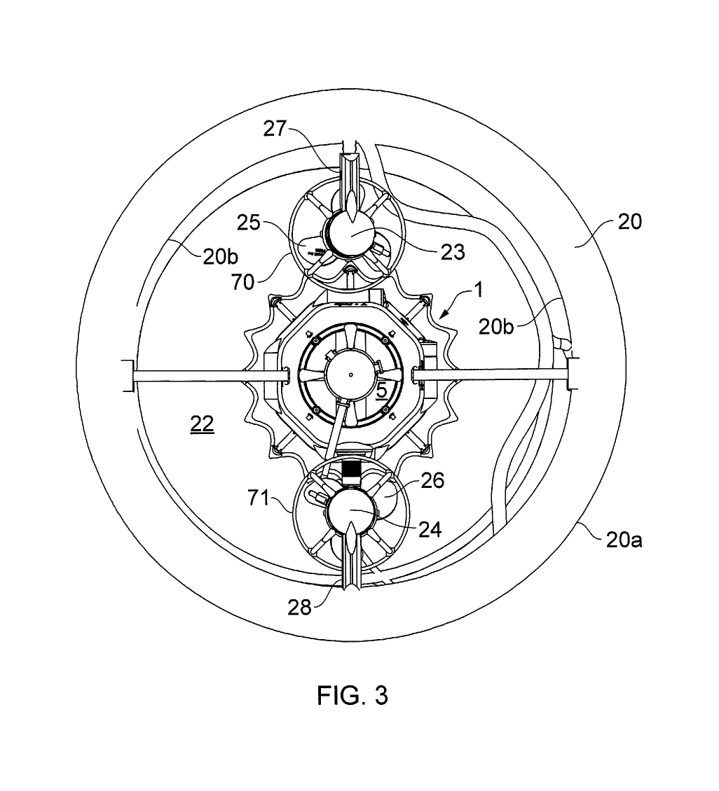

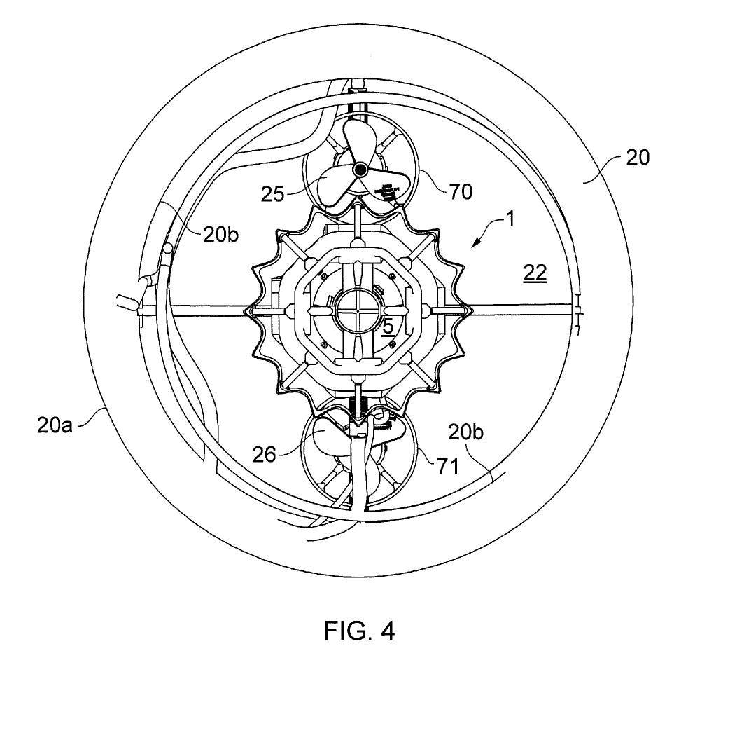

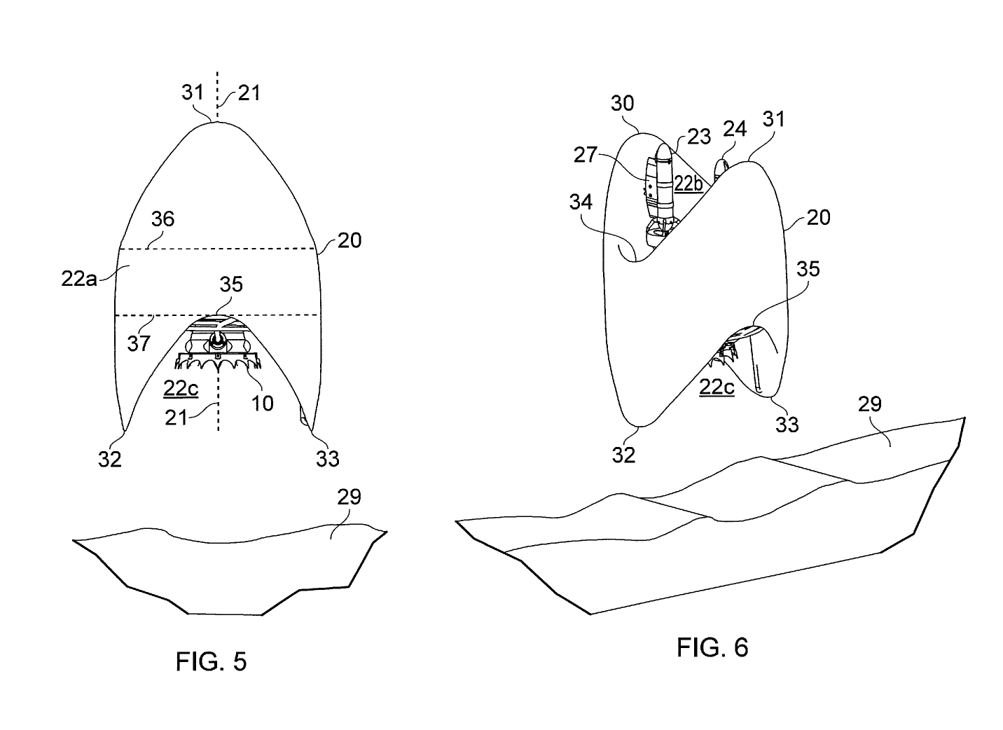

FIGS. 3-9 show a method of deploying the sensor 1 to the seabed 29 according to a first embodiment of the invention, using an annular submersible vehicle. The vehicle has a hull 20 which defines a hull axis 21 shown in FIG. 5 and appears substantially annular when viewed along the hull axis as shown in FIGS. 3 and 4.

A pair of propulsors are mounted symmetrically on opposite sides of the hull axis. The propulsors comprise motor units 23, 24 carrying propellers 25, 26 which are housed within shrouds 70, 71. The motor units 23, 24 are mounted on support members 27, 28 which in turn are pivotally mounted to the interior of the hull so that they can rotate by 360 degrees relative to the hull about an axis parallel to the pitch axis of the vehicle, thus providing thrust-vectored propulsion. Thus for example the propulsors 23, 24 can be rotated between the co-directed configuration shown in

FIG. 6 in which they provide a thrust force to propel the vehicle forward and along the hull axis, to a contra-directed configuration (not shown) in which they cause the vehicle to roll continuously around the hull axis, or to an angled configuration (not shown) in which their thrust vectors are co-directed and point at an acute angle to the hull axis. Two brushless DC electric motors drive the propellers 25, 26, and two DC electric motors drive the support members 27, 28.

The hull 20 has two bow apexes 30, 31 and two stern apexes 32, 33 which are offset by 90 degrees around the periphery of the hull, so the hull appears swept back when viewed from one side as shown in FIG. 5, and appears swept forward when viewed at 90 degrees to the viewing direction of FIG. 5. The bow apexes 30, 31 meet at a pair of points 34 and the stern apexes 32, 33 meet at a pair of points 35.

Referring to FIGS. 3 and 4, the hull 20 has an exterior surface 20a and an interior surface 20b. The interior surface 20b of the hull defines a duct 22 which runs from the bow of the vehicle to the stern of the vehicle and is open at both ends. Referring to FIG. 5, the duct has a fully enclosed annular portion 22a aft of the points 34 and forward of the points 35 (i.e. between the dashed lines 36, 37 shown in FIG. 5). The duct also has a partially open bow portion 22b between the bow apexes 30, 31 and a partially open stern portion 22c between the stern apexes 32, 33.

The sensor 1 is transported to the seabed with the bow apexes 30, 31 of the vehicle pointing down, and the sensor 1 positioned as shown in FIGS. 5-7. The sensor is positioned entirely within the duct 22 with its nose (i.e. the hydrophone 6) within the annular portion 22a of the duct and its stern (i.e. the skirt 3) within the stern portion 22c of the duct. This is the preferred arrangement (i.e. with the bow of the sensor aft of the bow of the vehicle, and the stern of the sensor forward of the stern of the vehicle) since it is compact and allows multiple vehicle/sensor assemblies to be stacked together. However it is possible that the struts may extend further aft so that some or all of the sensor is positioned outside the duct aft of the stern apexes 32, 33, in line with the duct 22.

Water flowing through the duct 22a, 22b, 22c also flows over the sensor 1 as it is transported to the seabed. The ribs 12 and channels 13 in the skirt of the sensor 1 provide hydrodynamic benefits in that they act as so-called “bluff grooves” which enable the sensor to fly well at low speeds and make it more stable in roll.

When the vehicle reaches the seabed, the thrust-vector propulsion system is operated to execute a turn so the vehicle is oriented as shown in FIGS. 5 and 6. This turn is required since the propulsors are positioned forward of the sensor 1 during transit to the seabed, but in an alternative arrangement the vehicle may be configured with the propulsors positioned aft of the sensor 1 during transit to the seabed, in which case no turn will be required.

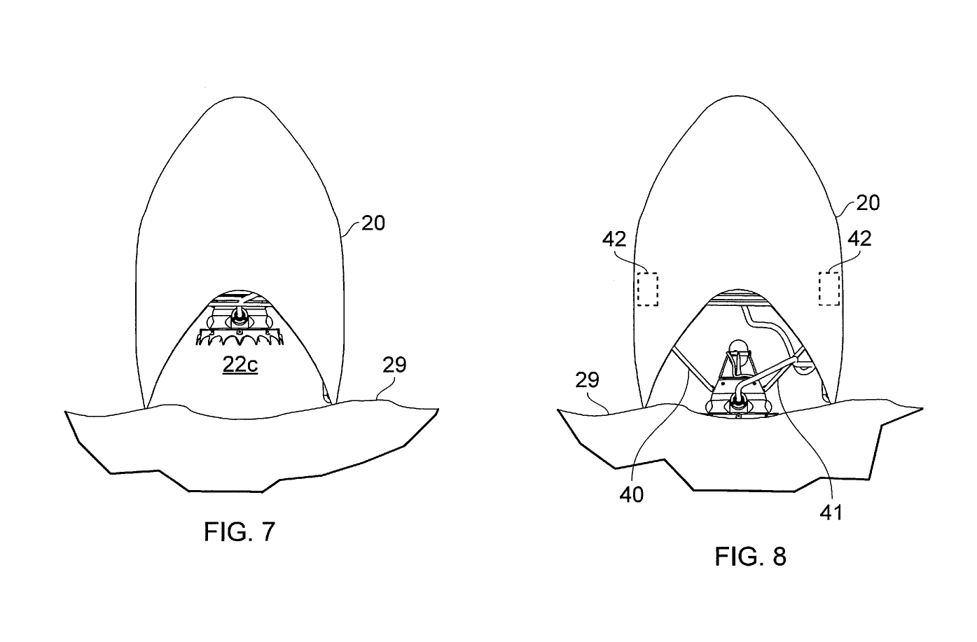

The vehicle is then allowed to drop (by the action of gravity) until it has landed on the seabed 29 as shown in FIG. 7. Note that no part of the sensor extends aft of the stern apexes 32, 33, so at this point the sensor has not yet engaged the seabed 29. As the vehicle lands and settles onto the seabed, the propulsors may be operated differentially or at an angle to the hull axis to ensure that the hull axis remains precisely vertical.

The sensor 1 is releasably mounted to the hull 20 on a pair of sliding struts 40, 41 shown in FIG. 8. After the vehicle has landed on the seabed, a pair of drive motors 42 are operated to move the struts 40, 41 down relative to the hull 20 and push the sensor into the seabed as shown in FIG. 8. The struts are longitudinally rigid so as to resist compression along their length and prevent them from collapsing as they push the sensor into the seabed.

The sensor 1 creates hydrodynamic lift force as it is transported to the seabed, and the struts transmit this hydrodynamic lift force to the hull of the vehicle. The sensor also creates hydrodynamic drag force as it is transported to the seabed and the struts transmit this hydrodynamic drag force to the vehicle. The sensor has an annular shape with a duct 5 which is open at both ends, and water flowing through the duct 22 of the vehicle also flows through the duct 4 of the device as it is transported to the seabed. The annular shape of the sensor 1 ensures that the sensor has a relatively high lift to drag ratio at low speed. Preferably the axis of the duct 5 is substantially parallel with the axis of the duct 22, although there may be a slight angle of inclination if required.

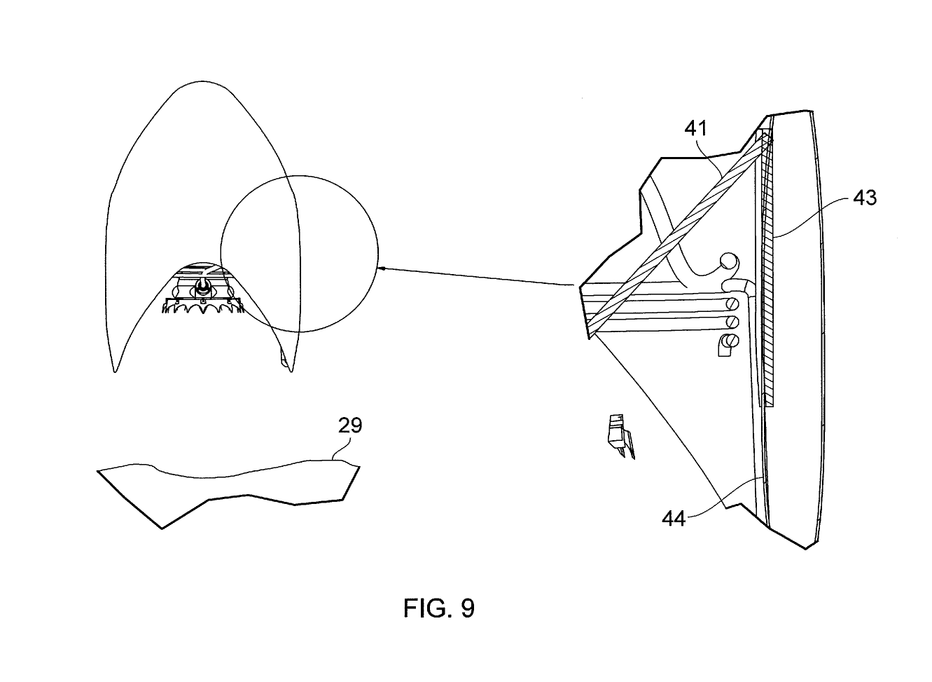

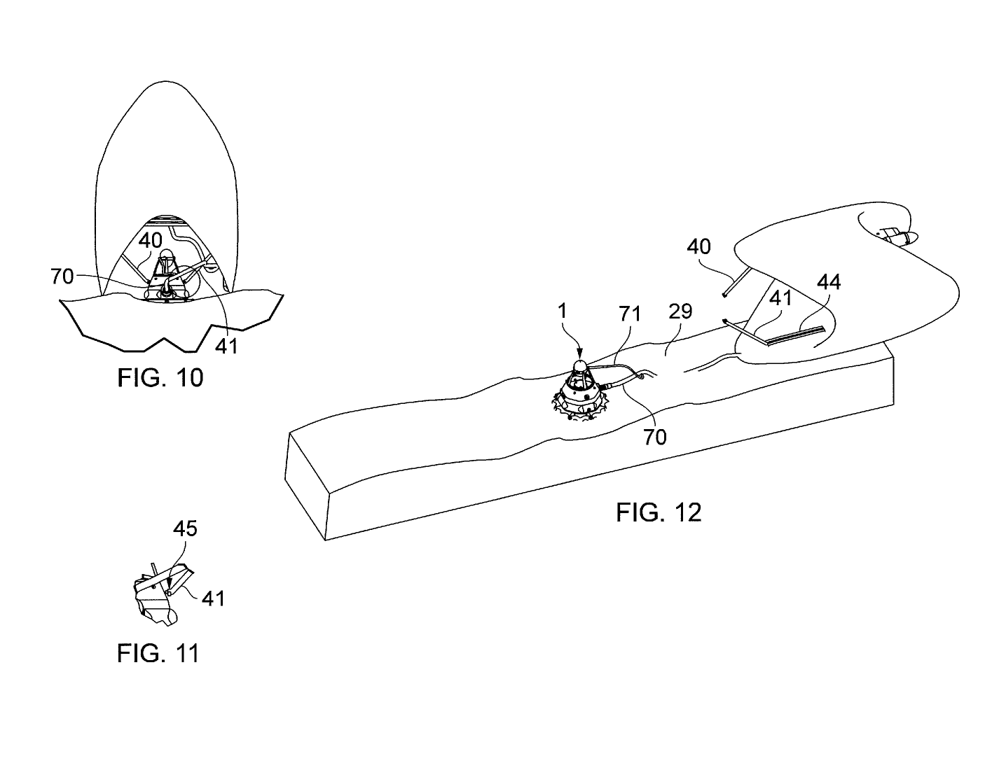

FIG. 9 shows one of the struts 41 in detail, the other strut 40 being identical. The strut 41 is carried on a slider 43 which is slidably mounted within a track 44 in the inner surface of the hull. The track 44 has a curved shape so that as the slider moves down it moves slightly way from the hull axis 21. After the points 10 of the teeth of the sensor skirt have been fully pushed into the seabed, the struts 40, 41 are released from the sensor 1 as shown in FIG. 11, by retracting a pair of pins 45 from a pair of holes 46 in the sensor (one of the holes 46 being shown in FIG. 1).

When the pins 45 have been released from the sensor, the struts 40, 41 spring back towards the hull due to the fact that the sliders 43 have moved apart slightly due to the curved shape of the tracks 44. After the struts have been released, the thrust-vector propulsion system is operated to move the vehicle off the seabed and park it next to the sensor 1 as shown in FIG. 12.

As the skirt 3 is pushed into the seabed by the struts, seabed material passes into the sensor duct 5. Since the duct 5 has a larger cross-sectional area towards the cutting edge at its base, the seabed material is compressed inwardly by the tapered frustoconical walls of the duct 5 as it passes through the duct. The tapered shape of the duct also means that the centre of gravity of the node is lower than it would be for a cylindrical node—thus increasing the stability of the node compared with a cylindrical one.

The node 1 is negatively buoyant with a weight in water of the order of 0.5-1.1 kg.

This helps to compress the seabed material passing through the duct and encourages positive coupling of seismic energy with the sensors.

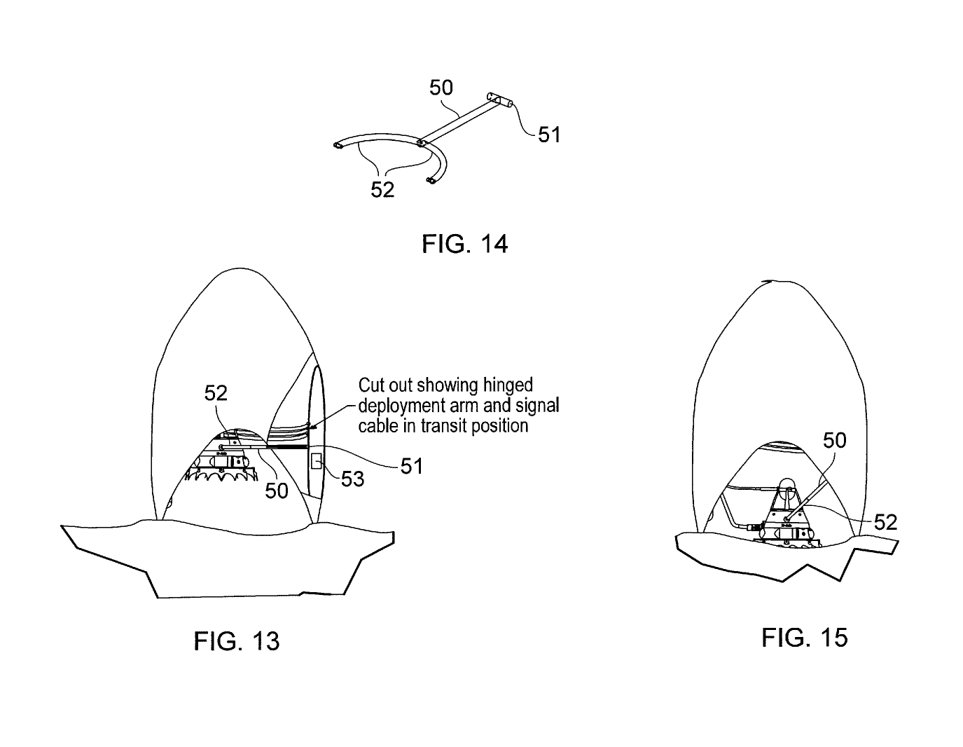

A vehicle/sensor assembly according to a second embodiment of the invention is shown in FIGS. 13-15. The sensor 1 is releasably mounted to the hull 20 on a single strut 50 which is pivotally mounted to the hull by a hinge 51. The strut 50 carries a pair of fingers 52, and each finger 52 has a retractable pin at its distal end for releasably gripping opposite sides of the sensor 1.

After the vehicle has landed on the seabed, a motor 53 is operated to rotate the strut 50 down relative to the hull 20 and push the sensor into the seabed as shown in FIG. 15.

After the points of the teeth of the sensor skirt have been fully pushed into the seabed, the fingers 52 are released from the sensor 1 by retracting the pins and/or by moving the fingers apart. After the struts have been released, the thrust-vector propulsion system is operated to move the vehicle off the seabed and park it next to the sensor 1.

Instead of rotating the arm 50 to deploy the sensor, the vehicle could transit to the sea bed with the arm 50 in the position of FIG. 15.

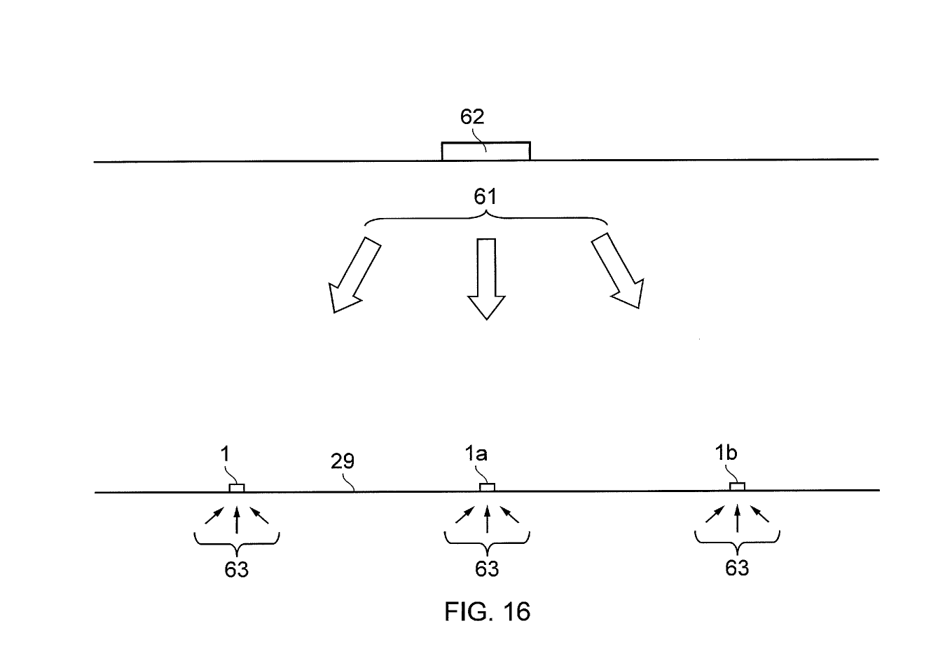

FIG. 16 shows a method of acquiring seismic data with the sensor 1. The sensor 1 is one of many such sensors 1, 1a, 1b etc which are deployed from a surface vessel 62, each node 1, 1a, 1b being transported to the seabed 29 by its own dedicated submersible vehicle.

A seismic survey is then carried out by transmitting an acoustic pulse 61 from the surface vessel 62. Each sensor then receives seismic waves 63 from the seabed which are transmitted to the onboard geophones and hydrophone via the skirt 3 and spike 60. Seismic data is then acquired with the seismic sensors 16,8,9,21, transmitted to the vehicle via flexible cables 50, 51 (shown in FIG. 12) and stored on the vehicle.

Shear waves are transmitted to the geophones 16,8,9 by the compressed seabed material, and also by the skirt 3 and support frame 2.

Although the invention has been described above with reference to one or more preferred embodiments, it will be appreciated that various changes or modifications may be made without departing from the scope of the invention as defined in the appended claims.

1. A method of deploying a device to the seabed, the method comprising providing a submersible vehicle, the vehicle having a hull which defines a hull axis and appears substantially annular when viewed along the hull axis, the hull having an interior defining a duct which is open at both ends; mounting the device to the hull on one or more struts so that it is positioned in line with the duct or at least partially within the duct; transporting the device to the seabed with the device mounted to the hull on the strut(s), water flowing through the duct as it does so; and deploying the device on the seabed after it has been transported to the seabed by the vehicle.

2. The method of claim 1 wherein the device remains mounted to the hull on the strut(s) as it is deployed on the seabed.

3. The method of claim 2 wherein the device is deployed on the seabed by using the momentum of the vehicle to push it into the seabed.

4. The method of claim 2 wherein the (or each) strut deploys the device on the seabed, and moves towards the seabed relative to the hull of the vehicle as it does so.

5. The method of claim 4 further comprising landing the vehicle on the seabed before deploying the device on the seabed with the (or each) strut.

6. The method of claim 1 further comprising transporting the device to the seabed with a nose of the vehicle and a nose of the device pointing down; executing a turn with the vehicle after it reaches the seabed so that the nose of the vehicle and the nose of the device are pointing up; and deploying the device to the seabed with the nose of the vehicle and the nose of the device pointing up.

7. The method of claim 6 wherein the vehicle comprises a twin thrust vector propulsion system comprising one or more pairs of propulsion devices, each pair comprising a first propulsion device pivotally mounted on a first side of the hull axis, and a second propulsion device pivotally mounted on a second side of the hull axis opposite to the first propulsion device, wherein the device is transported to the seabed with the thrust vectors of the propulsion devices pointing aft in line with the hull axis; and wherein the turn is executed by pivoting the propulsion devices so that their thrust vectors point at an acute angle to the hull axis.

8. The method of claim 1 further comprising retrieving the device from the seabed with the submersible vehicle.

9. The method of claim 1 wherein the device has an annular shape with a duct which is open at both ends, and wherein water flowing through the duct of the vehicle also flows through the duct of the device as it is transported to the seabed.

10. The method of claim 1 wherein the device is mounted to the hull on the one or more struts so that it is positioned at least partially within the duct.

11. The method of claim 10 wherein the device is mounted to the hull on the one or more struts so that it is positioned entirely within the duct.

12. The method of claim 1 further comprising releasing the device from the strut(s), or releasing the strut(s) from the vehicle, after embedding the device in the seabed and before moving the vehicle away from the device.

13. The method of claim 5 wherein the vehicle comprises a twin thrust vector propulsion system comprising one or more pairs of propulsion devices, each pair comprising a first propulsion device pivotally mounted on a first side of the hull axis, and a second propulsion device pivotally mounted on a second side of the hull axis opposite to the first propulsion device, and wherein the propulsion devices are operated differentially and/or at an angle to the hull axis to ensure that the vehicle lands on the seabed with its hull axis in a preferred orientation.

14. A method of acquiring seismic data from the seabed, the method comprising deploying a sensor to the seabed by the method of claim 1; and acquiring seismic data from the seabed with the sensor deployed on the seabed.

15. The method of claim 14 further comprising transmitting the seismic data from the sensor to the vehicle via a flexible umbilical cable.

16. The method of claims 15 wherein the sensor is retrieved from the seabed by towing it behind the vehicle with the flexible umbilical cable.

17. A vehicle/device assembly comprising a submersible vehicle with a hull which defines a hull axis and appears substantially annular when viewed along the hull axis, the interior of the hull defining a duct which is open at both ends; and a device which is releasably mounted to the hull of the vehicle on one or more struts and positioned in line with the duct or at least partially within the duct.

18. The assembly of claim 17 wherein the vehicle comprises a twin thrust vector propulsion system comprising one or more pairs of propulsion devices, each pair comprising a first propulsion device pivotally mounted on a first side of the hull axis, and a second propulsion device pivotally mounted on a second side of the hull axis opposite to the first propulsion device, wherein the propulsion devices can be rotated between a first configuration in which the thrust vectors of the propulsion devices point aft in line with the hull axis and a second configuration in which their thrust vectors point at an acute angle to the hull axis.

19. The assembly of claim 17 wherein the (or each) strut can move relative to the hull of the vehicle, and wherein the vehicle further comprises a drive device for moving the (or each strut) relative to the hull of the vehicle to deploy the device on the seabed.

20. The assembly of any of claim 17 wherein the (or each) strut further comprises a release mechanism for releasing the device from the strut or for releasing the strut from the hull of the vehicle
